(19) United States
(12) Patent Application Publication
(10) Pub. No.: US 2021/0233068 A1
(43) Pub. Date: Jul. 29, 2021

(54) SETTLEMENT SYSTEM, SETTLEMENT METHOD, USER DEVICE, AND SETTLEMENT PROGRAM

(71) Applicant: Nippon Telegraph and Telephone Corporation, Tokyo (JP)

(72) Inventors: Hiroki Watanabe, Musashino-shi, Tokyo (JP); Shigenori Ohashi, Musashino-shi, Tokyo (JP); Shigeru Fujimura, Musashino-shi, Tokyo (JP); Atsushi Nakadaira, Musashino-shi, Tokyo (JP); Kota HIDAKA, Musashino-shi, Tokyo (JP)

(21) Appl. No.: 16/972,240

(22) PCT Filed: May 20, 2019
(86) PCT No.: PCT/JP2019/019878

§ 371 Date: Dec. 4, 2020

(30) Foreign Application Priority Data
Jun. 6, 2018 (JP) 2018-108901

(51) Int. Cl. G06Q 20/38; G06Q 20/06

(52) U.S. Cl. CPC G06Q 20/389; G06Q 20/405; G06Q 20/0658; G06Q 20/3825

(57) ABSTRACT

The present invention efficiently coordinates a plurality of blockchains. A settlement system, including: a service provider device 2 that transmits a template information transaction including a template of a transaction to a network 4 of a first blockchain; a user device that transmits a payment information transaction including a payment amount and an electronic signature which is generated by using the template of the transaction registered in the first blockchain; and a smart contract 41 included in the first blockchain, in which the smart contract 41 uses the payment amount and the template of the transaction to verify the electronic signature included in the payment information transaction, and the service provider device 2 uses the template of the transaction, the electronic signature, and the payment amount registered in the first blockchain to generate a settlement transaction and transmits the settlement transaction to a network 3 of a second blockchain.

### TECHNICAL FIELD

The present invention relates to a technique of a blockchain and particularly relates to a technique of coordinating a plurality of blockchains.

### BACKGROUND ART

Mechanisms that can ensure the reliability without the need for centralized management are becoming popular, centering on Bitcoin, digital cryptocurrency. In one of these mechanisms called a blockchain, the reliability of communicated information is ensured by a process of consensus building within a distributed network, and the soundness is maintained by preventing frauds, such as falsifications and double-spending, as the entire system.

In the blockchain, information pieces on cryptocurrency transactions between participants (transactions) are put together into a unit called a “block”, and blocks are linked in the form of a chain and managed in chronological order. A new block is approved through a consensus algorithm in a distributed network such as Proof of Work. The approval of a new block means that the currency transaction recorded inside the block is consented to in the entire system.

The ledger of a series of these transaction information pieces managed using the blockchain is called a “distributed ledger”, and the nodes (terminals) participating in the network have the same distributed ledger. Nowadays, blockchain platform technologies have also been developed in which besides currency transactions, advanced script code is registered in the distributed ledger and in which the execution and results of the script code are also subjected to consensus. For example, in a blockchain platform called Ethereum, script code is executed using a transaction as an input, the execution result is stored in a key-value store having a tree structure, and a representative value of the store at the time is also recorded in the block in the distributed ledger.

In cryptocurrencies, a transaction is limited to a currency transaction record such as “who passed how much to whom”. However, in these succeeding blockchain technologies, the user him/herself can programmably set information recorded by using a transaction and script code. Consequently, it is easy to apply the blockchain to various applications other than the currency transaction such as securities trading, insurance service, and copyright management. These platform techniques are called smart-contract type blockchains because a consensus about a contract is obtained from participants.

### PRIOR ART DOCUMENT

### Patent Document

Patent document 1: Japanese Patent Application Publication No. 2017-204070

### SUMMARY OF THE INVENTION

### Problem to be Solved by the Invention

Patent document 1 discloses a technique of coordinating multiple blockchains having different roles and making it possible to provide, according to payment on one cryptocurrency type blockchain, a service on the other blockchain. According to the method of Patent document 1, a payment transaction for a cryptocurrency blockchain is contained in a transaction of a service-provision blockchain. Consequently, a user (that is, a payer) and a service provider (that is, a person who is paid) can manage both the payment of the consideration and service provision by only monitoring the service-provision blockchain.

In the method of Patent document 1, it is required for the service provider (the person who is paid) to monitor the service-provision blockchain constantly during the payment of the consideration to the service. The service provider verifies the validity of the payment transaction for the cryptocurrency blockchain contained in the service-provision blockchain by using the own terminal, and once the validity is verified, the service provider broadcasts a transaction indicating the provision of the service to a network for the service-provision blockchain. In this case, the service provider needs a connection to the service-provision blockchain from the verification of the payment until the provision of the service.

Incidentally, in order to construct a system capable of auditing with higher transparency by taking advantage of the characteristics of the blockchain, it is desirable to eliminate intermediate systems as many as possible and to allow autonomous execution of the processes.

In the method of Patent document 1, since the service provider intermediates from the verification of the payment until the provision of the service, there is a possibility that the series of processes are not executed properly due to a failure or an injustice of the terminal of the service provider. Additionally, the constant monitoring of the service-provision blockchain is also costly in terms of an operational for the service provider.

The present invention is made in light of the above-described problems, and an object of the present invention is to efficiently coordinate a plurality of blockchains.

### Means for Solving the Problem

To achieve the above-described object, a first present invention is a settlement system in which a first blockchain and a second blockchain are coordinated, including: a service provider device that transmits a template information transaction including a template of a transaction to a network of the first blockchain; a user device that transmits a payment information transaction including a payment amount and an electronic signature which is generated by using the template of the transaction registered in the first blockchain to the network of the first blockchain; and a smart contract included in the first blockchain, in which the smart contract verifies the electronic signature included in the payment information transaction by using the payment amount and the template of the transaction, and the service provider device generates a settlement transaction by using the template of the transaction, the electronic signature, and the payment amount registered in the first blockchain, and transmits the settlement transaction to a network of the second blockchain.

A second present invention is a settlement method with a first blockchain and a second blockchain coordinated, including: transmitting, by a service provider device, a template information transaction including a template of a transaction to a network of the first blockchain; generating, by a user device, an electronic signature by using the template of the transaction registered in the first blockchain; transmitting, by a user device, a payment information transaction including the electronic signature and a payment amount to the network of the first blockchain; verifying, by a smart contract included in the first blockchain, the electronic signature included in the payment information transaction by using the payment amount and the template of the transaction; generating, by the service provider device, a settlement transaction by using the template of the transaction, the electronic signature, and the payment amount registered in the first blockchain; and transmitting, by the service provider device, the settlement transaction to a network of the second blockchain.

A third present invention is a user device in a settlement system in which a first blockchain and a second blockchain are coordinated, including: a remittance transaction generation unit that transmits a remittance transaction of remitting a predetermined amount of a guarantee deposit to a network of the second blockchain; and a payment transaction generation unit that generates an electronic signature by using a template of a transaction that is registered by a service provider device in the first blockchain, and transmits a payment information transaction including the electronic signature and a payment amount to a network of the first blockchain.

A fourth present invention is a settlement program that causes a computer to function as the above-described user device.

### Effect of the Invention

According to the present invention, it is possible to efficiently coordinate multiple blockchains.

### BRIEF DESCRIPTION OF THE DRAWINGS

FIG. 1 is a diagram illustrating an overall configuration of a settlement system according to an embodiment of the present invention.

FIG. 2 is a block diagram illustrating a configuration of a blockchain client.

FIG. 3 is a conceptual diagram indicating “setting” processing.

FIG. 4 is an image diagram of a transaction template.

FIG. 5 is a conceptual diagram indicating “payment” processing.

FIG. 6 is a flowchart indicating processing of creating an electronic signature by a user device.

FIG. 7 is a flowchart indicating processing of payment verification by a bridging contract.

FIG. 8 is a conceptual diagram indicating “settlement” processing.

### MODE FOR CARRYING OUT THE INVENTION

Hereinafter, an embodiment of the present invention is described with reference to the drawings.

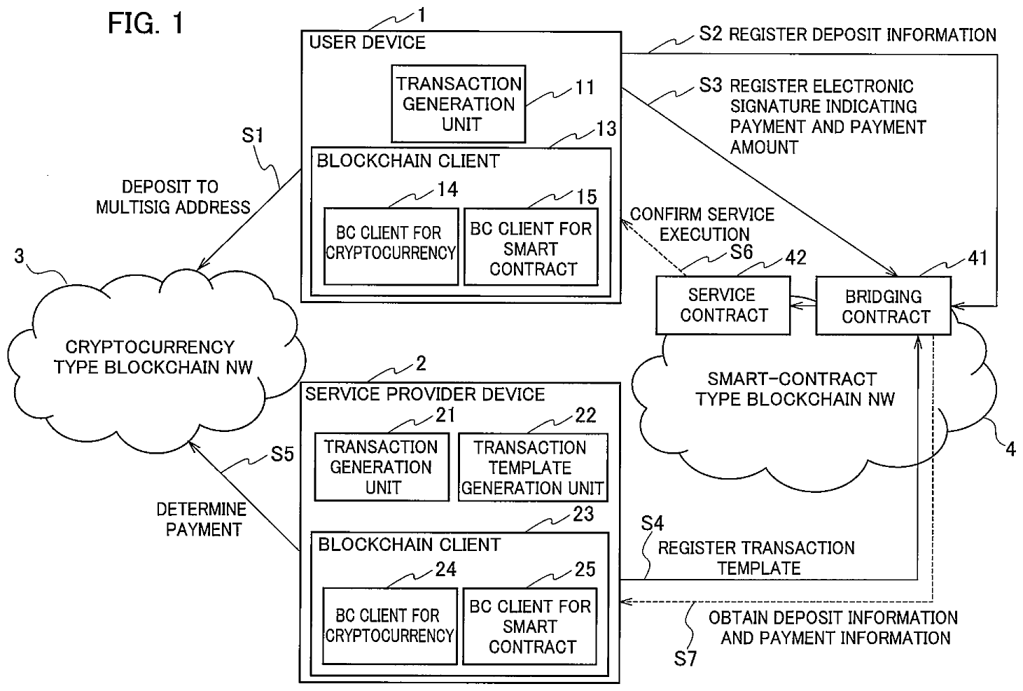

FIG. 1 is an overall configuration diagram of a settlement system according to an embodiment of the present invention. The settlement system is a system in which payment using cryptocurrency on a cryptocurrency type blockchain (a second blockchain) and service provision on a smart-contract type blockchain (a first blockchain) are coordinated.

The cryptocurrency type blockchain is a distributed ledger shared by nodes participating in a P2P network 3 (hereinafter, a “cryptocurrency type network”) of the blockchain. A transaction history of the cryptocurrency is registered in the cryptocurrency type blockchain. Once the transaction in which transaction information about how much cryptocurrency is transferred from where to where is described is broadcasted to the cryptocurrency type network 3, a block including the transaction is generated, and the generated block is added to the tail end of the cryptocurrency type blockchain.

The smart-contract type blockchain is a distributed ledger shared by nodes participating in a P2P network 4 (hereinafter, a “smart-contract type network”) of the blockchain. Once a transaction is broadcasted to the smart-contract type network 4, a block including the transaction is generated, and the generated block is added to the tail end of the smart-contract type blockchain. Once the block is added, a script code (that is, a smart contract) registered in advance is executed on a terminal of the participating node with the transaction that is included in the block received as an input, and thus the distributed ledger is updated. Ethereum, Hyperledger Fabric, and so on may be an example of a platform implementing the smart-contract type blockchain as described above.

A user device 1 is a device used by a user of a service provided by the smart-contract type blockchain. The user device 1 includes a transaction generation unit 11 and a blockchain client 13.

A transaction generation unit 11 generates transactions required for “setting” and “payment”, which are out of the later-described three types of processing (steps) of “setting”, “payment”, and “settlement”. The generated transactions are transmitted to the corresponding blockchain networks 3 and 4 through the blockchain client 13.

In the “setting” processing, the user device 1 generates a “transaction of depositing from the address of the user to the multisig address” and transmits the transaction to the cryptocurrency type network 3 (step S1). Thereafter, the user device 1 generates a “transaction of registering deposit information” and transmits the transaction to the smart-contract type network 4 (step S2).

In the “payment” processing, the user device 1 generates a “transaction of registering an electronic signature indicating the payment and a payment amount” and transmits the transaction to the smart-contract type network 4 (step S3).

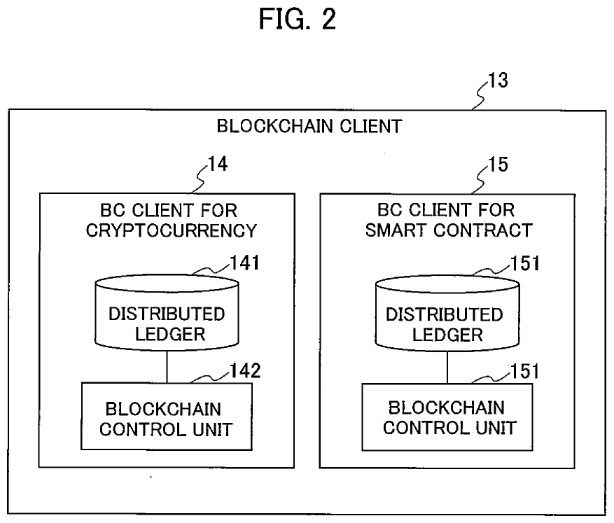

FIG. 2 is a block diagram illustrating a configuration of the blockchain client 13. The user device 1 of this embodiment is connected with the cryptocurrency type network 3 and the smart-contract type network 4. Accordingly, the blockchain client 13 includes a cryptocurrency type blockchain client 14 and a smart-contract type blockchain client 15.

The cryptocurrency type blockchain client 14 includes a distributed ledger 141 and a blockchain control unit 142. The distributed ledger 141 stores the latest blockchain in almost real time by being loosely synchronized by the blockchain control unit 142 with all terminals (devices) connected to the cryptocurrency type network 3.

The blockchain control unit 142 maintains the system of the blockchain by the autonomous decentralized coordination with the terminals connected to the cryptocurrency type network 3. Specifically, the blockchain control unit 142 accesses the distributed ledger 141 and reads or updates the blockchain in the distributed ledger 141. The blockchain control unit 142 transmits the transaction to the cryptocurrency type network 3.

The smart-contract type blockchain client 15 includes a distributed ledger 151 and a blockchain control unit 152. The distributed ledger 151 and the blockchain control unit 152 are similar to the distributed ledger 141 and the blockchain control unit 142.

A service provider device 2 is a device used by a service provider who operates the service on the smart-contract type blockchain. The service provider provides the user with an arbitrary service (for example, registration of a digital content right or the like) with the reception of the payment from the user.

The service provider device 2 includes a transaction generation unit 21, a transaction template generation unit 22, and a blockchain client 23.

The transaction generation unit 21 and the transaction template generation unit 22 generate transactions required for “setting” and “settlement”, which are out of the three types of processing of “setting”, “payment”, and “settlement”.

In the “setting” processing, the service provider device (the transaction template generation unit 22) generates a “transaction of registering a transaction template” and transmits the transaction to the smart-contract type network (step S4). The transaction template is described later.

In the “settlement” processing, the service provider device 2 (transaction generation unit 21) generates a “transaction of determining payment from the multisig address to the address of the service provider” and transmits the transaction to the cryptocurrency type network 3 (step S5).

Since the blockchain client 23 is similar to the blockchain client 13 (see FIG. 2) of the user device 1, the description thereof is omitted herein.

In this embodiment, two smart contracts are registered in advance on the smart-contract type network 4. Specifically, according to the protocol of the smart-contract type blockchain, abridging contract 41 and a service contract 42 are registered in a distributed ledger 151 on each terminal connected to the network 4.

The bridging contract is a smart contract that coordinates the cryptocurrency type blockchain and the smart-contract type blockchain. The bridging contract receives information on the payment (the electronic signature and the payment amount) from the user device 1 and verifies the validity thereof.

The service contract is a smart contract that executes the service (for example, transfer of a content right or the like) performed by the service provider after the bridging contract confirms the validity of the payment information.

Both the smart contracts include an API (Application Programming Interface) that confirms and refers to the state of a variable stored therein. For example, the user device 1 uses the API to obtain the execution result of the service contract from the own distributed ledger 151 (step S6). On the other hand, the service provider device 2 uses the API to obtain the deposit information and the payment information registered in the bridging contract from the own distributed ledger (step S7). Note that, the broken line in steps S6 and S7 in FIG. 1 indicates the processing of referring to the distributed ledger stored in the own device.

Next, processing of this embodiment is described. In this embodiment, the three types of processing of “setting”, “payment”, and “settlement” are performed.

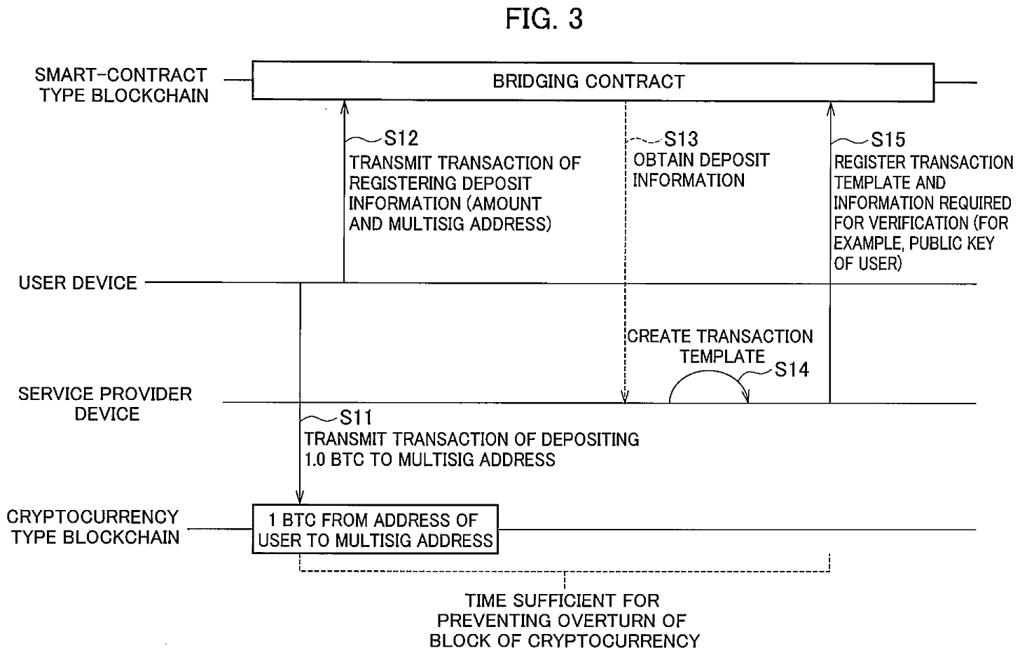

FIG. 3 illustrates a conceptual diagram of the “setting” processing. In the “setting” processing, preparations required for the next “payment” processing are made.

First, the user device 1 generates a remittance transaction and transmits (broadcasts) the remittance transaction to the cryptocurrency type network 3 (step S11). The remittance transaction is a transaction of remitting a predetermined amount of a deposit (a guarantee deposit) from the address of the user to the multisig address co-managed by the user and the service provider.

The multisig address is an address that requires electronic signatures of multiple people for a transaction for withdrawal on the cryptocurrency type blockchain. In this embodiment, a multisig address that requires an electronic signature of the user and an electronic signature of the service provider is used. In this case, it is assumed that 1.0 BTC is remitted to the multisig address, for example.

With the remittance transaction transmitted to the cryptocurrency type network 3, a block including the remittance transaction is generated, and the block is reflected to the distributed ledgers (the blockchains) of all the terminals connected to the cryptocurrency type network 3 by the loose synchronization of the terminals. In this case, the remittance of the deposit of 1.0 BTC from the address of the user to the multisig address in the cryptocurrency type blockchain is determined.

Next, the user device 1 transmits a transaction (a guarantee deposit information transaction) for registering deposit information about the deposit to the smart-contract type network 4 (step S12). The transaction includes at least the amount of the remitted deposit and may further include information such as an ID of the remittance transaction in step S11 and the multisig address as the deposit information.

With the transaction transmitted to the smart-contract type network 4, a block including the transaction is generated, and the block is reflected to the distributed ledgers of all the terminals connected to the smart-contract type network 4 by the loose synchronization of the terminals. Consequently, in all the terminals, the deposit information is registered in a storage region managed by the bridging contract of the distributed ledger.

The service provider device 2 obtains the deposit information registered by the user device 1 from the bridging contract registered in the own distributed ledger (step S13). The service provider device 2 uses the obtained deposit information to create a template of the transaction (the transaction template) (step S14). In this case, the transaction template is a format of an incomplete transaction deformed from the transaction of the cryptocurrency type blockchain. Specifically, the transaction template is a format of a transaction obtained by excluding information about the “remittance amount” and “all the electronic signatures” from the “transaction indicating remittance (withdrawal) from the multisig address to the service provider device”.

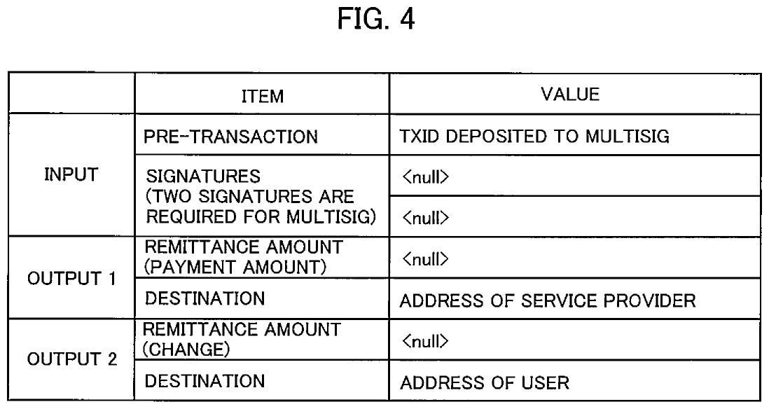

FIG. 4 illustrates an image of the transaction template. In the illustrated example, “all the electronic signatures” required for input and the “remittance amounts” required for output are “null” (blank). In this example, two kinds of remittance amounts are set. One is the amount to be substantially remitted to the service provider, and the other is the amount to be remitted to the user as the change.

Note that, in step S11, 1.0 BTC is deposited to the multisig address. In the next “payment” processing, the user device 1 updates the “remittance amount (that is, the payment amount and the change)” and the “electronic signatures” of the transaction template within the range of the deposit (1.0 BTC) to generate the payment information transaction and passes the transaction to the bridging contract.

Then, after the elapse of a period of time sufficient for determining the block including the remittance transaction transmitted in step S11 in the cryptocurrency type blockchain, the service provider device 2 transmits a template information transaction including the transaction template generated in step S14 to the smart-contract type network 4 (step S15).

Consequently, a block including the template information transaction is generated, and the block is reflected to the distributed ledgers of all the terminals connected to the smart-contract type network 4 by the loose synchronization of the terminals. In this case, the transaction template is registered in the bridging contract of the smart-contract type blockchain.

In this process, the service provider device 2 may put not only the transaction template but also information required for the verification of the electronic signature in the next payment processing (for example, a public key for the address of cryptocurrency of the user device 1) into the template information transaction to be transmitted to and registered in the bridging contract. Otherwise, the bridging contract may hold the information required for the verification of the electronic signature in advance.

Next, the “payment” processing is described.

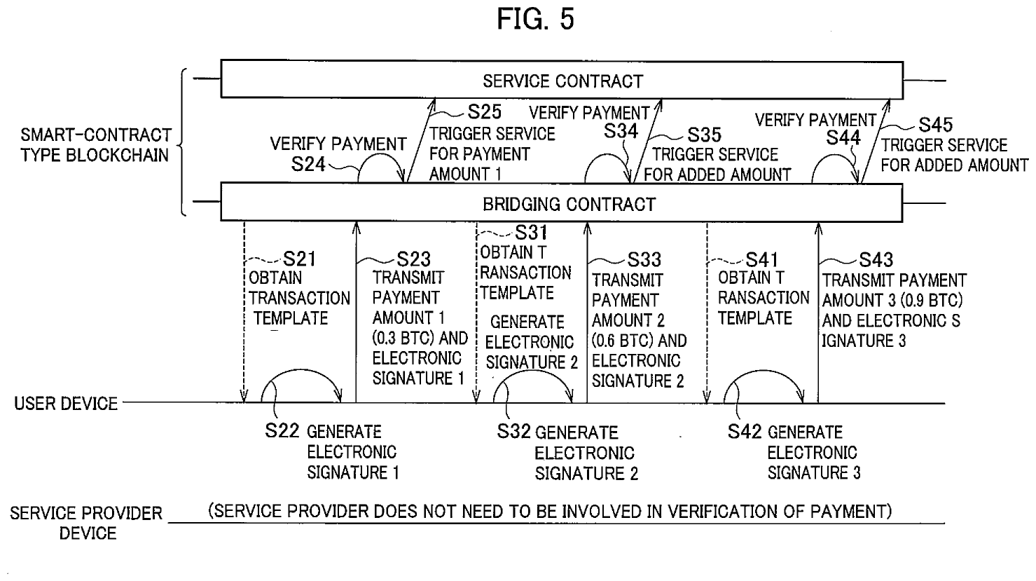

FIG. 5 illustrates a conceptual diagram of the “payment” processing. FIG. 5 illustrates an example of performing the payment processing three times while updating the payment amount.

First, in the first payment, the user device 1 obtains the transaction template registered by the service provider device 2 in the “setting” processing from the bridging contract of the own distributed ledger (step S21). Then, the user device 1 creates an electronic signature 1 using the transaction template (step S22).

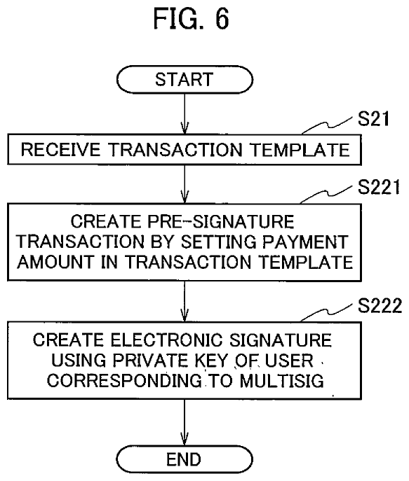

FIG. 6 is a flowchart indicating the processing of step S21 and step S22 by the user device 1. As described above, the user device 1 obtains the transaction template from the bridging contract (step S21). Then, the user device 1 sets a payment amount 1 (in this case, 0.3 BTC) to the obtained transaction template and generates a pre-signature transaction 1 (step S221). Then, the user device 1 generates the electronic signature 1 by using a private key of the user corresponding to the multisig address for the pre-signature transaction 1 (step S222).

Referring back to FIG. 5, the user device 1 generates a transaction (the payment information transaction) that includes the payment amount 1 and the electronic signature 1 for registering the information in the bridging contract and transmits the transaction to the smart-contract type network 4 (step S23). Consequently, a block including the transaction is generated, and the block is reflected to the distributed ledgers of all the terminals connected to the smart-contract type network 4 by the loose synchronization of the terminals. In this case, in the smart-contract type blockchain, the payment amount 1 and the electronic signature 1 are registered in the bridging contract of each terminal.

When the block including this transaction is registered in the distributed ledger, predetermined processing (the payment verification) is executed by the bridging contract on all the terminals (step S24).

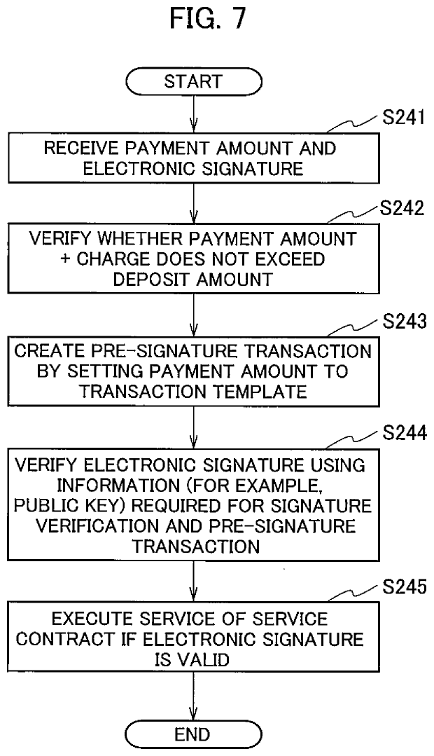

FIG. 7 is a flowchart indicating the verification processing of step S24 performed by the bridging contract. First, the bridging contract obtains the “transaction of registering the electronic signature 1 and the payment amount 1 (0.3 BTC)” transmitted by the user device 1 in step S23 (step S241). The bridging contract verifies whether a sum of the payment amount 1 of the obtained transaction and the payment charge thereof (the charge to be paid to a miner on the cryptocurrency type blockchain or the like) does not exceed the deposit amount (1.0 BTC) (step S242).

When it is verified that there is no exceeding (when the validity is verified), the bridging contract verifies the electronic signature included in the payment information transaction by using the payment amount and the template of the transaction. Specifically, the bridging contract creates a pre-signature transaction by setting the payment amount 1 to the transaction template registered in advance in the bridging contract in the setting processing (see FIG. 3) (step S243). In the setting of the payment amount 1, the remittance amount of the change to the user (1.0 BTC−0.3 BTC−the payment charge) is also properly calculated and set on the bridging contract. Next, the bridging contract uses the created pre-signature transaction to verify the electronic signature 1 (step S244).

As a method of verifying the electronic signature, it is known for an ECDSA electronic signature used for Bitcoin and the like that a public key for the verification can be restored by using a pre-signature message and the electronic signature.

Thus, the bridging contract uses, for example, the information required for the signature verification registered in advance in step S15 of FIG. 3 and the like (a public key, a hash of the public key, and so on) to verify the validity of the electronic signature 1 of the transaction obtained in step S241. That is, the bridging contract restores the public key by using the generated pre-signature transaction and the electronic signature 1 transmitted from the user device 1, and when the restored public key and the public key registered in advance match, the bridging contract verifies that the electronic signature 1 is valid. On the other hand, when the restored public key and the public key registered in advance do not match, the bridging contract verifies that the electronic signature 1 is invalid.

Then, when the validity of the electronic signature 1 is verified, the bridging contract calls the service contract (step S245).

Referring back to FIG. 5, when it is verified that the electronic signature 1 is valid, the bridging contract calls the service contract to execute a service according to the payment amount 1 (step S25). Specifically, the bridging contract calls a method of the service contract with the payment amount 1 and the like used as parameters (step S25). In this way, the service contract executes a predetermined service (for example, transfer of a digital content right) according to the payment amount.

In FIG. 5, the user device 1 performs the payment processing of steps S21 to S25 three times, and the service by the service contract is performed every time the processing is performed. The second payment processing (step S31 to S35) and the third payment processing (step S31 to S35) are similar to the first payment processing (step S21 to S25).

Note that, the payment amounts have the relationship of the payment amount 1 (0.3 BTC)<a payment amount 2 (0.6 BTC)<a payment amount 3 (0.9 BTC), and the last payment amount (0.9 BTC) is the eventual settlement amount. In this case, the payment amount of the second time or later is obtained by adding a payment amount of the current service to the previous payment amount. The example illustrated in FIG. 5 shows that the user device 1 performs the payment three times and the service for 0.3 BTC is provided each time.

Note that, although the user device 1 broadcasts the payment information transactions of three times to the smart-contract type network 4 (steps S23, S33, and S43) in FIG. 5, if the “settlement” processing described later is performed in the third payment, the service provider device 2 cannot perform the settlement using the payment information from the first and the second. Even if the payment information from the first and the second is used to generate the settlement transaction and the broadcasting is performed, the payment information is shut out in the process of the consensus verification on the cryptocurrency type blockchain and becomes void in the network.

Lastly, the “settlement” processing is described.

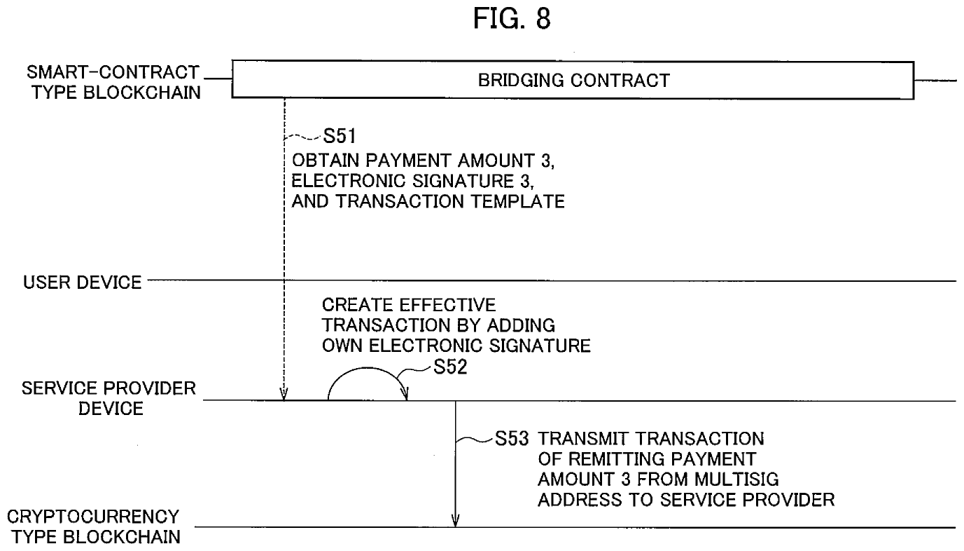

FIG. 8 is a diagram indicating the “settlement” processing. The service provider device 2 closes the payment at arbitrary timing and reflects the payment on the cryptocurrency type blockchain. First, the service provider device 2 obtains the eventual payment amount 3, an electronic signature 3, and the transaction template from the distributed ledger (the bridging contract) of the own device (step S51).

Then, the service provider device 2 generates a settlement transaction by setting the payment amount 3 and the electronic signature 3 to the transaction template. The settlement transaction at this time point is a “transaction of remitting from the multisig address to the service provider, to which the electronic signature of only the user device 1 is added”. That is, the settlement transaction at this time point is not a valid transaction since the transaction has no electronic signature of the service provider device 2.

In view of this, in order to make the remittance from the multisig address valid, the service provider device 2 adds the electronic signature to the settlement transaction by the own private key corresponding to the multisig on the own terminal and creates a transaction that is valid on the cryptocurrency type blockchain (step S52). The post-signature settlement transaction becomes valid on the cryptocurrency type blockchain since the transaction has the two electronic signatures of the user and the service provider.

Note that, when the multisig address is not used, the service provider device 2 does not need to add the own electronic signature to the settlement transaction.

The service provider device 2 transmits the post-signature settlement transaction to the cryptocurrency type network 3 to make the settlement (step S53). With the settlement transaction transmitted to the cryptocurrency type network 3, a block including the settlement transaction is generated, and the block is reflected to the distributed ledgers of all the terminals connected to the cryptocurrency type network 3 by the loose synchronization of the terminals. In this case, in the cryptocurrency type blockchain, the payment amount 3 of 0.9 BTC is remitted from the multisig address to the address of the service provider, and the settlement is completed.

Note that, until the service provider device 2 transmits the settlement transaction to the cryptocurrency type network 3 (step S53), that is, until the service provider closes the payment, the user device 1 can perform the n-th payment processing illustrated in FIG. 5 to rewrite the payment amount and receive the additional service provision.

In this embodiment described above, the service provider device 2 does not intermediate in the “payment” processing, and from the verification of the payment to the provision of the service are all executed on the smart-contract type blockchain. That is, the processes executed by the service provider device 2 in Patent document 1 are charged by the smart-contract type blockchain.

Consequently, in this embodiment, the service provider device 2 needs no connection to the smart-contract type blockchain from the verification of the payment to the provision of the service. That is, since the service provider device 2 does not need to constantly monitor the smart-contract type blockchain, the operation cost is decreased.

Additionally, in this embodiment, since from the service provider device 2 does not intermediate from the verification of the payment to the provision of the service, it is possible to avoid a situation where the sequential payment processing is not properly executed due to a failure of the service provider device 2 or an injustice of the service provider.

Moreover, in this embodiment, since from the verification of the payment to the provision of the service are autonomously executed by the bridging contract and the service contract of the smart-contract type blockchain, it is possible to construct a system capable of auditing with higher transparency.

Furthermore, in this embodiment, since the transaction template is registered in the smart-contract type blockchain and the user device 1 and the service provider device 2 each obtain the transaction template to be used from the own distributed ledger, it is possible to reduce the number of transmission of the transactions, inhibit the bloating of the blocks, and reduce the calculation cost of the blocks.

Additionally, in this embodiment, the transaction using the multisig address that requires the electronic signature of the user and the electronic signature of the service provider is used. Consequently, it is possible to prevent the user device 1 from registering the settlement transaction in the cryptocurrency type blockchain and using the cryptocurrency without permission. That is, in this embodiment, only the service provider device 2 can add the own electronic signature to the settlement transaction and register the transaction in the cryptocurrency type blockchain. That is, it is possible to allow the service provider device 2 to control the timing of the settlement and determine the settlement at arbitrary timing.

Note that, it is possible to use a versatile computer system including a CPU (Central Processing Unit, processor), a memory, a storage (HDD: Hard Disk Drive, SSD: Solid State Drive), a communication device, an input device, and an output device as the user device 1 and the service provider device 2, for example. In the computer system, the functions of the corresponding devices are implemented with the CPU executing a predetermined program loaded on the memory. For example, the functions of the user device 1 and the service provider device 2 are implemented such that the program for the user device 1 is executed by a CPU of the user device 1 and the program for the service provider device 2 is executed by a CPU of the service provider device 2, respectively.

Additionally, the program for the user device 1 and the program for the service provider device 2 can be stored in a computer-readable recording medium such as an HDD, an SSD, a USB memory, a CD-ROM, a DVD-ROM, or an MO and also can be distributed through a network.

Moreover, the present invention is not limited to the above-described embodiment, and various modifications are possible without departing from the gist. For example, the smart contract of this embodiment includes two kinds of smart contracts, the bridging contract and the service contract, as illustrated in FIG. 1; however, a single smart contract may have the functions of both the bridging contract and service contract.

Furthermore, although the case of the single service contract is described as an example in this embodiment, there may be multiple service contracts. In this case, the service contracts execute different kinds of services, respectively, and the bridging contract calls a service contract corresponding to the service designated by the payment information transaction.

### EXPLANATION OF THE REFERENCE NUMERALS

1 user device
11 transaction generation unit
13 blockchain client
14 blockchain client for cryptocurrency
15 blockchain client for smart contract
2 service provider device
21 transaction generation unit
22 transaction template generation unit
23 blockchain client
24 blockchain client for cryptocurrency
25 blockchain client for smart contract
3 network of cryptocurrency type blockchain
4 network of smart-contract type blockchain
41 bridging contract
42 service contract

1. A settlement system in which a first blockchain and a second blockchain are coordinated, comprising:
a service provider device that transmits a template information transaction including a template of a transaction to a network of the first blockchain;
a user device that transmits a payment information transaction including a payment amount and an electronic signature which is generated by using the template of the transaction registered in the first blockchain to the network of the first blockchain; and
a smart contract included in the first blockchain, wherein
the smart contract verifies the electronic signature included in the payment information transaction by using the payment amount and the template of the transaction, and
the service provider device generates a settlement transaction by using the template of the transaction, the electronic signature, and the payment amount registered in the first blockchain, and transmits the settlement transaction to a network of the second blockchain.

2. The settlement system according to claim 1, wherein
the smart contract generates a pre-signing transaction by setting the payment amount to the template of the transaction registered in the first blockchain, verifies the electronic signature by using the pre-signing transaction, and executes a service according to the payment amount when a validity is verified.

3. The settlement system according to claim 1, wherein
the user device:
transmits a remittance transaction of remitting a predetermined amount of a guarantee deposit to a multisig address to the network of the second blockchain, and
transmits a guarantee deposit information transaction including the predetermined amount to the network of the first blockchain, and
wherein the service provider device adds own electronic signature to the settlement transaction and transmits a post-signing settlement transaction to the network of the second blockchain.

4. The settlement system according to claim 3, wherein
the smart contract verifies whether a sum obtained by adding a charge to the payment amount does not exceed the predetermined amount of the guarantee deposit.

5. A settlement method with a first blockchain and a second blockchain coordinated, comprising:
transmitting, by a service provider device, a template information transaction including a template of a transaction to a network of the first blockchain;
generating, by a user device, an electronic signature by using the template of the transaction registered in the first blockchain;
transmitting, by a user device, a payment information transaction including the electronic signature and a payment amount to the network of the first blockchain;
verifying, by a smart contract included in the first blockchain, the electronic signature included in the payment information transaction by using the payment amount and the template of the transaction;
generating, by the service provider device, a settlement transaction by using the template of the transaction, the electronic signature, and the payment amount registered in the first blockchain; and
transmitting, by the service provider device, the settlement transaction to a network of the second blockchain.

6. A user device in a settlement system in which a first blockchain and a second blockchain are coordinated, comprising:
a remittance transaction generation unit that transmits a remittance transaction of remitting a predetermined amount of a guarantee deposit to a network of the second blockchain; and
a payment transaction generation unit that generates an electronic signature by using a template of a transaction that is registered by a service provider device in the first blockchain, and transmits a payment information transaction including the electronic signature and a payment amount to a network of the first blockchain.

7. A computer readable storage medium comprising a settlement program that causes a computer to function as a user device in a settlement system in which a first blockchain and a second blockchain are coordinated, comprising:
a remittance transaction generation unit that transmits a remittance transaction of remitting a predetermined amount of a guarantee deposit to a network of the second blockchain; and
a payment transaction generation unit that generates an electronic signature by using a template of a transaction that is registered by a service provider device in the first blockchain, and transmits a payment information transaction including the electronic signature and a payment amount to a network of the first blockchain.
